(19) United States
(12) Patent Application Publication
(10) Pub. No.: US 2002/0087315 A1
(43) Pub. Date: Jul. 4, 2002

(54) Computer-implemented multi-scanning language method and system

(76) Inventors: Victor Wai Leung Lee, Waterloo (CA); Otman A. Basir, Kitchener (CA); Fakhreddine O. Karray, Waterloo (CA); Jiping Sun, Waterloo (CA); Xing Jing, Waterloo (CA)

Correspondence Address: Jones, Day, Reavis and Pogue, North Point, 901 Lakeside Avenue, Cleveland, OH, 44114, US

(21) Appl. No.: 09/863,576

(22) Filed: May 23, 2001

Related U.S. Application Data
(60) Provisional application No. 60/258,911, filed on Dec. 29, 2000.

(51) Int. Cl. G10L 15/14; G10L 15/00

(52) U.S. Cl. 704/256

(57) ABSTRACT

A computer-implemented method and system for speech recognition of a user speech input. The user speech input which contains utterances from a user is received. A first language model recognizes at least a portion of the utterances from the user speech input. The first language model has utterance terms that form a general category. A second language model is selected based upon the identified utterances from use of the first language model. The second language model contains utterance terms that are a subset category of the general category of utterance terms in the first language model. Subset utterances are recognized with the selected second language model from the user speech input.

### RELATED APPLICATION

This application claims priority to U.S. provisional application Serial No. 60/258,911 entitled “Voice Portal Management System and Method” filed Dec. 29, 2000. By this reference, the full disclosure, including the drawings, of U.S. provisional application Serial No. 60/258,911 are incorporated herein.

### FIELD OF THE INVENTION

The present invention relates generally to computer speech processing systems and more particularly, to computer systems that recognize speech.

### BACKGROUND AND SUMMARY OF THE INVENTION

Previous speech recognition systems have been limited in the size of the word dictionary that may be used to recognize a user's speech. This has limited the scope of such speech recognition system to handle a wide variety of user's spoken requests. The present invention overcomes this and other disadvantages of previous approaches. In accordance with the teachings of the present invention, a computer-implemented method and system are provided for speech recognition of a user speech input. The user speech input which contains utterances from a user is received. A first language model recognizes at least a portion of the utterances from the user speech input. The first language model has utterance terms that form a general category. A second language model is selected based upon the identified utterances from use of the first language model. The second language model contains utterance terms that are a specific category of the general category of utterance terms in the first language model. The utterance in the specific category is recognized with the selected second language model from the user speech input.

Further areas of applicability of the present invention will become apparent from the detailed description provided hereinafter. It should be understood however that the detailed description and specific examples, while indicating preferred embodiments of the invention, are intended for purposes of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description and the accompanying drawings, wherein:

FIG. 1 is a system block diagram depicting the software-implemented components of the present invention used to recognize utterances of a user;

FIG. 2 is flowchart depicting the steps used by the present invention in order to recognize utterances of a user;

FIG. 3 is a system block diagram depicting utilization of the present invention additional tools to recognize utterances of a user;

FIG. 4 is a system block diagram an example of the present invention in processing a printer purchase request;

FIGS. 5-8 are block diagrams depicting various recognition assisting databases; and

FIG. 9 is a system block diagram depicting an embodiment of the present invention for selecting language models.

### DETAILED DESCRIPTION OF THE PREFERRED EMBODIMENT

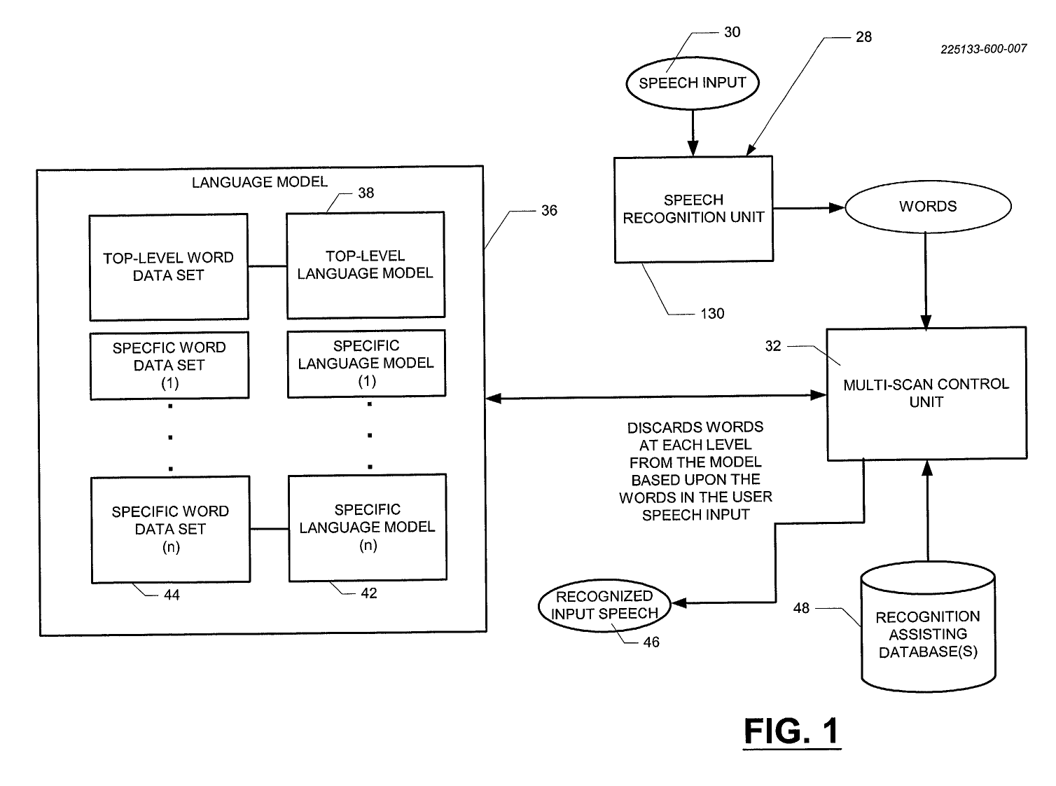

FIG. 1 depicts the speech recognition system 28 of the present invention. The speech recognition system 28 analyses user speech input 30 by applying multiple language models 36 organized for multi-level information detection. The language models form conceptually-based hierarchical tree structures 36 in which top-level models 38 detect a generic term, while lower-level sub-models 42 detect increasingly specific terminology. Each language model contains a limited number of words related to a predicted area of user interest. This domain specific model is more flexible than existing keyword systems that detect only one word in an utterance and use that word as a command to take the user to the next level in the menu.

The speech recognition system 28 includes a multi-scan control unit 32 that iteratively selects and scans models from the multiple language models 36. The multiple language models 36 may be hidden Markov language models that are domain specific and at different levels of specificity. Hidden Markov models are described generally in such references as “Robustness In Automatic Speech Recognition”, Jean Claude Junqua et al., Kluwer Academic Publishers, Norwell, Mass., 1996, pages 90-102. The models in the multiple language models 36 are of varying scope. For example, one language model may be directed to the general category of printers and includes such top level product information as language models to differentiate among various computer products such as printer, desktop, and notebook. Other language models may include more specific categories within a product. For example, for the printer product, specific product brands may be included in the model, such as Lexmark or Hewlett-Packard.

The multi-scan control unit 32 examines the user's speech input 30 to recognize the most general word in the speech input 30. The multi-scan control unit 32 selects the most general model from the multiple language models 36 that contains at least one of the general words found within the speech input 30. The multi-scan control unit 32 uses the selected model as the top-level language model 38 within the hierarchy 36. The multi-scan control unit 32 recognizes words via the top-level language model 38 in order to form the top-level word level data set 40.

The top-level word data set contains the words that are currently recognized in the speech input 30. The recognized words in data set 40 are used to select the next model from the multi-language models 34. Typically, the next selected language model is a model that is a more specific domain within the top-level language model 38. For example, if the top-level language model 38 is a general products language model, and the user speech input 30 contains the term printer, then the next model retrieved from the multi-language models 34 would contain more specific printer product words, such as Lexmark. The multi-scan control unit 32 iteratively selects and applies more specific models from the multi-language models 34 until the words in the speech input 30 have been sufficiently recognized so as to be able to perform the application at hand. In this way, one or more specific language models 42, 44 identify more specific words in the user speech input 30.

For example, the multi-scan unit 32 iteratively uses language models from the model hierarchy 36 so as to recognize a sufficient number of words to be able to process a request from a user to purchase a specific printer. The recognized input speech 46 for that example may be sent to an electronic commerce transaction computer server in order to facilitate the printer purchase request. The multi-scan control unit 32 may utilize recognition assisting databases 48 to further supplement recognition of the speech input 30. The recognition assisting databases 48 may include what words are typically found together in a speech input. Such information may be extracted by analyzing word usage on internet web pages. Another exemplary database to assist word recognition is a database that maintains personalized profile that already have been recognized for a particular user or for users that have previously submitted requests which are similar to the request at hand. Previously recognized utterances are also used to assist the database. For example, if a user had previously asked for prices for a Lexmark printer, the words recognized in that previous time would be used to assist in recognizing those words again in this current speech input 30. Other databases to assist in word recognition are discussed below.

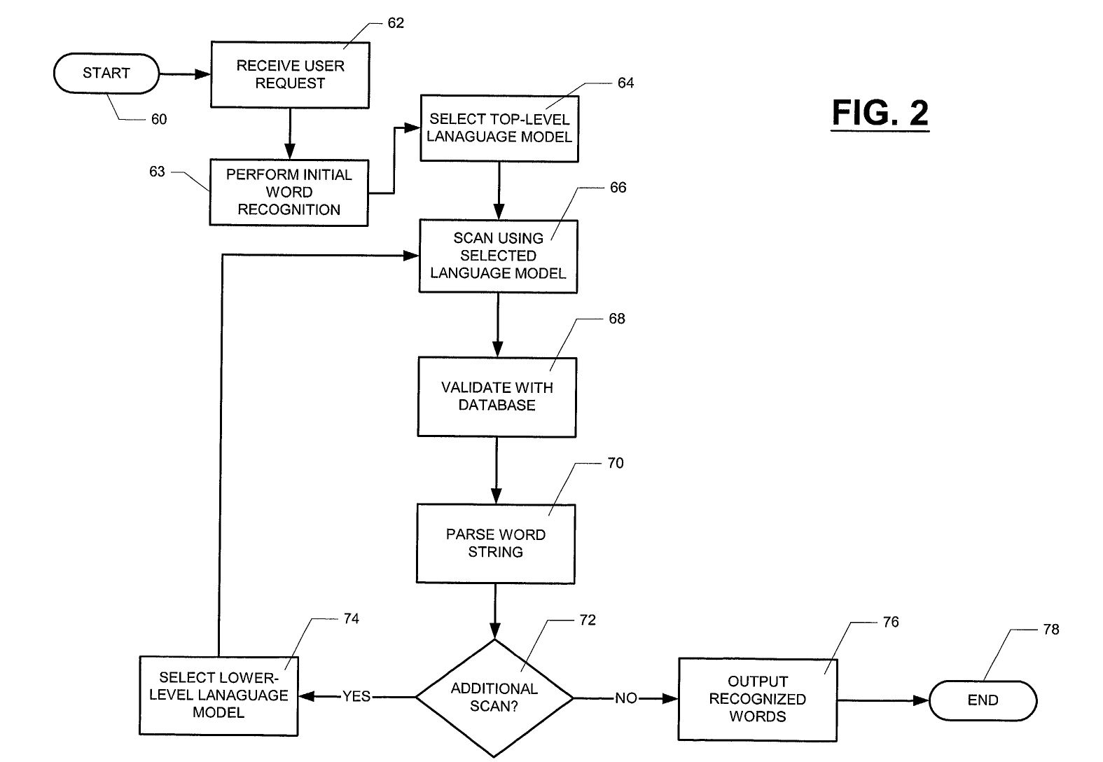

FIG. 2 depicts the steps used by the present invention in order to recognize words by a multiple scan of a user's input speech. Start block 60 indicates that process block 62 receives the user's request. Process block 63 performs the initial word recognition that is used by process block 64 to select a top-level language model. Process block 64 selects the model from the multiple language models that most probably matches the context of the user's request. For example, if the user's request is focused upon purchasing a product, then the top-level product language model is used to recognize words in the user's request. Selection of the top level language model is context and application specific. For example in a weather service telephony application, the top level language model may be selected based upon the phone number dialed by a user within a telephony system. The phone number is associated with what language should be initially used. However, it should be understood that for some top level language model designs, especially ones that have a wide variety of applications, the initial recognition may be necessary in order to determine which specific language model should be used.

Process block 66 scans the user request with the selected top-level language model. The scan by process block 66 results in words being associated with recognition probabilities. For example, the word “printer” which is found in the top-level language model has a high degree of likelihood of being recognized, whereas other words such as “Lexmark” which is not in the product top-level language model would normally come out as phone-based filler words. Process block 68 applies the recognition assisting databases in order to further determine the certainty of recognized words. The databases may increase the probability score or decrease the probability score depending upon the comparison between the recognized words and the data that is found in the speech recognition assisting databases. From the scans of process block 66 and process block 68, process block 70 reconfirms the recognized words by parsing the word string. The parsed words are fit into a syntactic model that contains slots for the different syntactic types of words. Such slots include a subject slot, a verb slot, etc. Slots that are not filled are used to indicate what additional information may be needed from the user.

Decision block 72 examines whether additional scans are needed in order to recognize more words in the user request or to reassess the recognition probabilities of the already recognized words. This determination by decision block 72 as to whether additional scans are needed is more specifically based upon the degree in which the recognition of the utterance is parsed by a syntactic-semantic parser, and whether the recognized key elements (such as nouns and verbs) is sufficient for further action. If decision block 72 determines that an additional scan is needed, process block 74 selects a lower-level language model based upon the words that have already been recognized. For example, if the word “printer” has already been recognized, then the specific printer products language model is selected.

Process block 66 scans the user input again using the selected lower-level language model of process block 74. Process block 68 scans the user input with the recognition assisting databases to increase or decrease the recognition probabilities of the words that were recognized during the scan of process block 66. Process block 70 parses the list of the recognized words. Decision block 72 examines whether additional scans are needed. If a sufficient number of words or all of the words have been satisfactorily recognized, then the recognized words are provided as output for use within the application at hand. Processing terminates at end block 78.

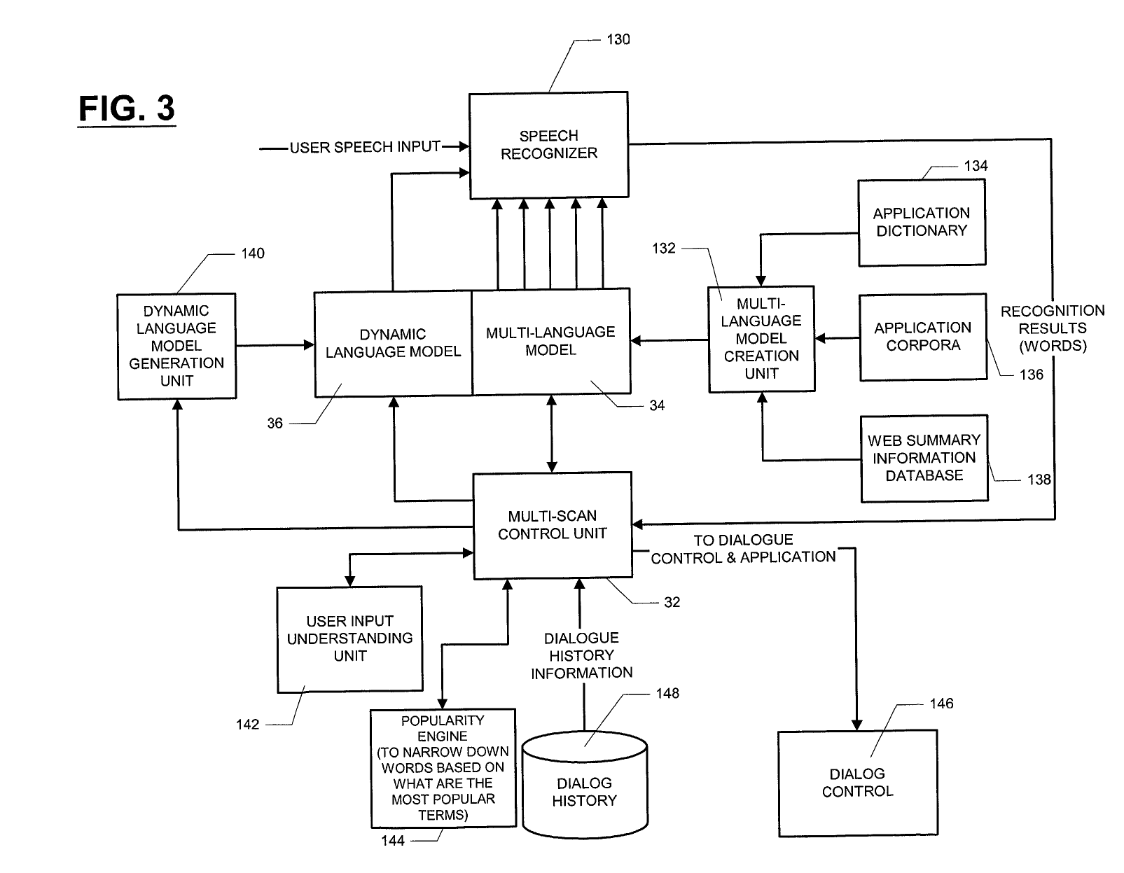

FIG. 3 depicts a detailed embodiment of the present invention. With reference to FIG. 3, the speech recognition unit or decoder 130 scans (or maps) user utterances from a telephony routing system. Recognition results are passed to the multi-scan control unit 32. The speech recognition unit 130 uses the multi-language models 34 and dynamic language model 36 in its Viterbi search process to obtain recognition hypotheses. The Viterbi search process is generally described in “Robustness In Automatic Speech Recognition”, Jean Claude Junqua et al., Kluwer Academic Publishers, Norwell, Mass., 1996, page 97.

The multi-scan control unit 32 may relay information to a dialogue control unit 146. It can receive information about the user's dialogue history 148 and information from the understanding unit 142 about concepts. The user input understanding unit 142 contains conceptual data from personal user profiles based on the user's usage history. The multi-scan control unit 32 sends data to the dynamic language model generation unit 140, the dynamic language model 36, and the multi-language models 34 in order to facilitate the creation of dynamic language models, and the sequence in which they will be scanned in a multi-scanning process.

The multi-language model creation unit 132 has access to the application dictionary 134, containing the corpus of the domain in use, the application corpora 136, and the web summary information database 138 containing the corpus from web sites. The multi-language model creation unit 132 determines how the sub-models are created, along with their hierarchical structure, in order to facilitate multi-scan process.

The popularity engine 144 contains data compiled from multiple users' histories that has been calculated for the prediction of likely user requests. This increases the accuracy of word recognition. Users belong to various user groups, distinguished on the basis of past behavior, and can be predicted to produce utterances containing keywords from language models relevant to, for example, shopping or weather related services.

The user speech input is detected by the speech recognition system 130 and is partitioned into phonetic components for scanning by multiple language models and is turned into recognition hypotheses as word strings. The multi-scan control unit 32 chooses the relevant multi-language model 34 for scanning to match the input for recognizable keywords that indicate the most likely context for the user request. A multi-language model creation unit 132 accesses databases to create multi-models. It makes use of the application dictionary 134 and application corpora 136 containing terms for the domain applications in use, or the web summary information database 138 which contains terms retrieved from relevant web sites. When required, the multi-scan control unit 32 can use a dynamic language model 36 that contains subsets of words for refining a more specific context for the user request, allowing the correct words to be found.

The dynamic language model generation unit 140 generates new models based on user collocations and areas of interest, allowing the system to accommodate an increasing variety of usage. The user input understanding unit 142 accesses the user's personal profile determined by usage history to further refine output from the multi-scan control unit 32 and relays the output to the dynamic language model generation unit 140. The popularity engine 144 also has an impact on the output of the multi-scan control unit 32, directing scanning for the most probable match for words in the user utterance based on past requests.

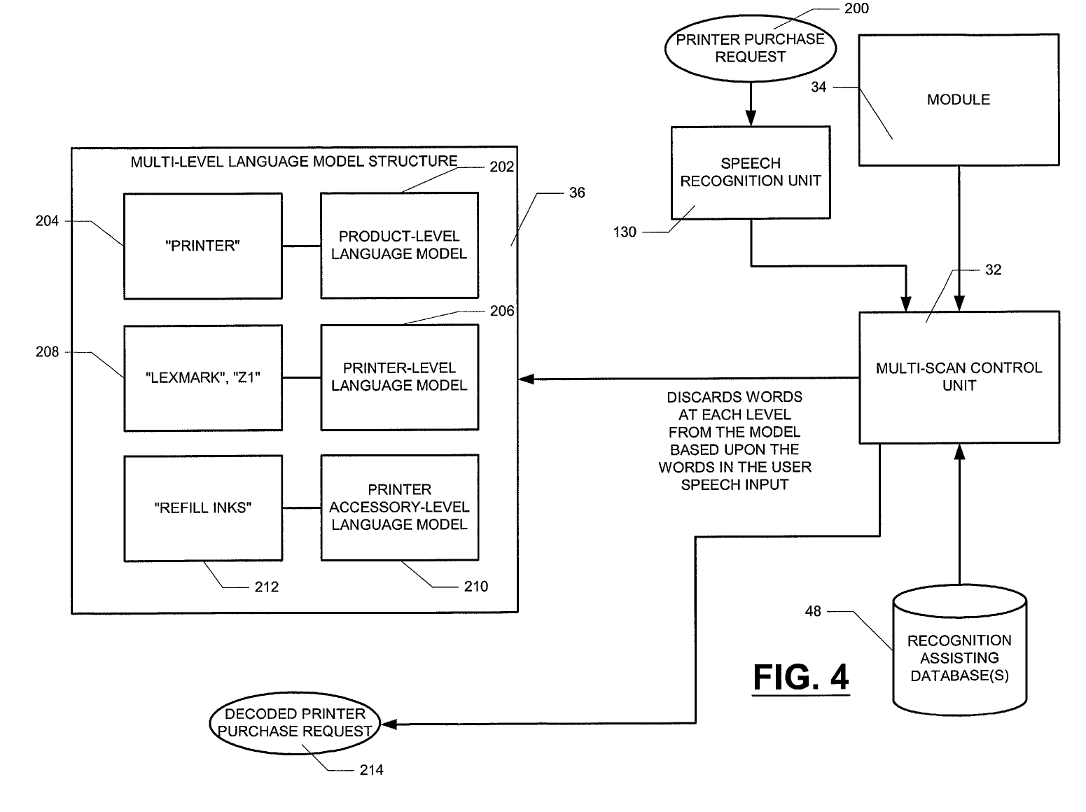

FIG. 4 depicts a scenario where the user wishes to buy an inkjet cartridge for a particular printer. Note that the bracketed words below represent what the user says but are not recognized as they are not included in the language model being used. Therefore they usually come out as filler words such as a phone-based filler sequence. The speech recognition unit 130 relays, “Do you sell [refill ink] for [Lexmark Z11] inkjet printers?” to the multi-scan control unit 32. The query is scanned and the word “printer” 204 in the general product name model 202 triggers an additional scanning by the subset model 206 for printers. This subset discards words like “laser” and “dot matrix” and goes to the inkjet product sub-model, which contains the particular brand and model number and eliminates other brands and models. The terms “Lexmark” and “Z11” 208 are recognized by model 206. The next subset contains a printer accessories model 210, and “refill ink” 212 from the user request is detected, eliminating other subset possibilities, and arriving at an accurate decoding 214 of the user input speech request. The recognition assisting databases 48 assisted the multi-scan control unit 32 by providing the multi-scanned models with the most popular words about printers, as well as the most commonly used phrases by the user. This information is collected from the web, previous utterances, as well as relevant databases.

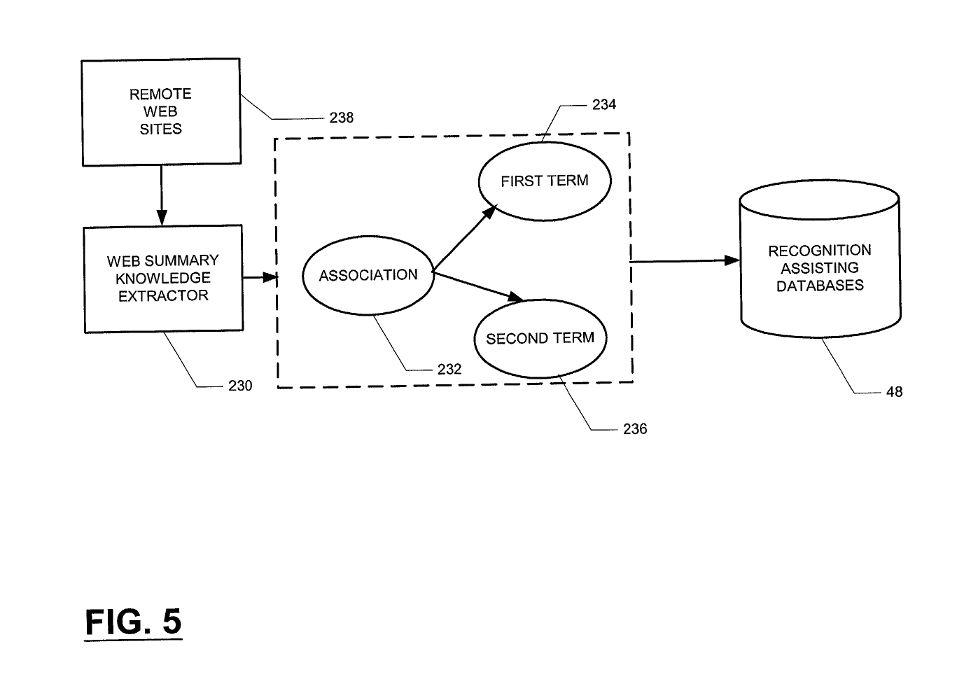

FIG. 5 depicts the web summary knowledge database 230 that forms one of the recognition assisting databases 48. The web summary information database 230 contains terms and summaries derived from relevant web sites 238. The web summary knowledge database 230 contains information that has been reorganized from the web sites 238 so as to store the topology of each site 238. Using structure and relative link information, it filters out irrelevant and undesirable information including figures, ads, graphics, Flash and Java scripts. The remaining content of each page is categorized, classified and itemized. Through what terms are used on the web sites 238, the web summary database 230 forms associations 232 between terms (234 and 236). For example, the web summary database may contain a summary of the Amazon.com web site and creates an association “topic-media” between the term “golf” and “book” based upon the summary. Therefore, if a user input speech contains terms similar to “golf” and “book”, the present invention uses the association 232 in the web summary knowledge database 230 to heighten the recognition probability of the terms “golf” and “book” in the user input speech.

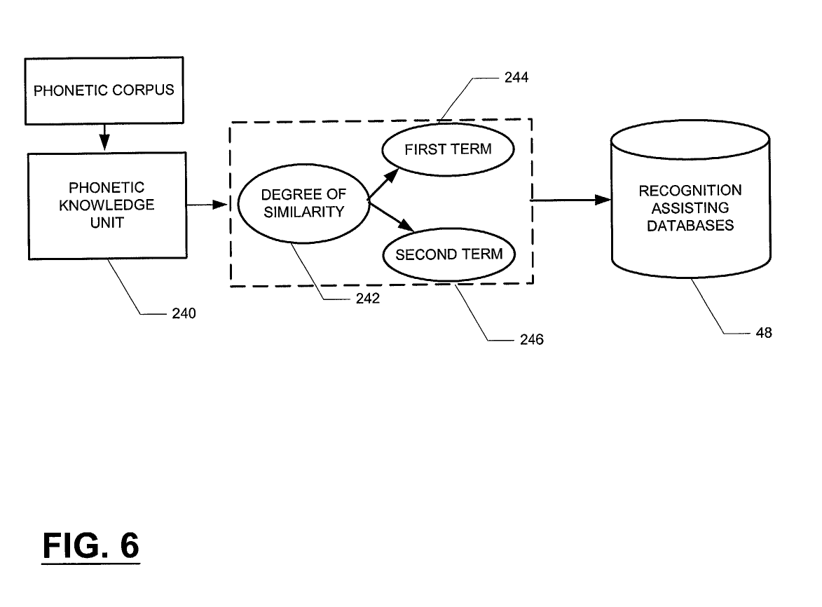

FIG. 6 depicts the phonetic knowledge unit 240 that forms one of the recognition assisting databases 48. The phonetic knowledge unit 240 encompasses the degree of similarity 242 between pronunciations for distinct terms 244 and 246. The phonetic knowledge unit 240 understands basic units of sound for the pronunciation of words and sound to letter conversion rules. If, for example, a user requested information on the weather in Tahoma, the phonetic knowledge unit 240 is used to generate a subset of names with similar pronunciation to Tahoma. Thus, Tahoma, Sonoma, and Pomona may be grouped together in a node specific language model for terms with similar sounds. The present invention analyzes the group with other speech recognition techniques to determine the most likely correct word.

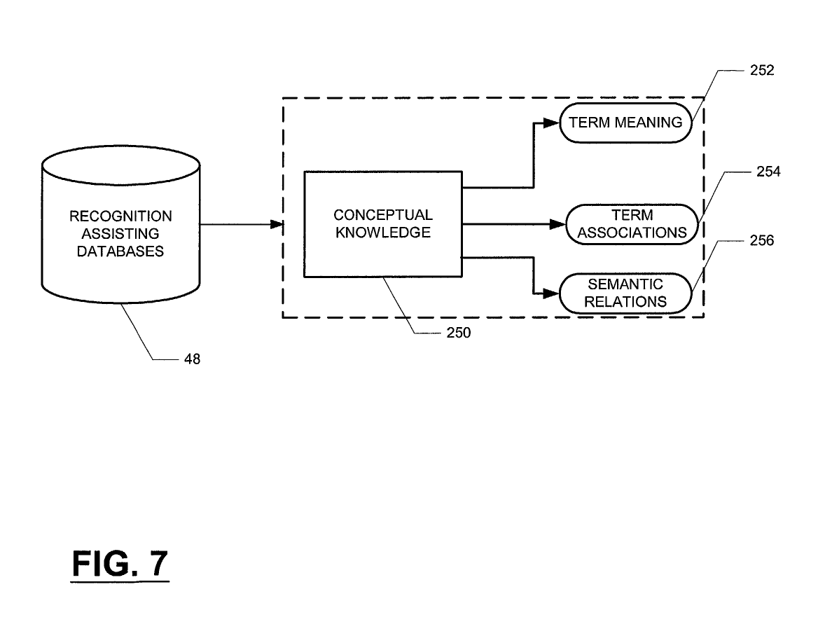

FIG. 7 depicts the conceptual knowledge database unit 250 that forms one of the recognition assisting databases 48. The conceptual knowledge database unit 250 encompasses the comprehension of word concept structure and relations. The conceptual knowledge unit 250 understands the meanings 252 of terms in the corpora and the conceptual relationships between terms/words. The term corpora means a large collection of phonemes, accents, sound files, noises and pre-recorded words.

The conceptual knowledge database unit 250 provides a knowledge base of conceptual relationships among words, thus providing a framework for understanding natural language. For example, the conceptual knowledge database unit contains associations 254 between the term “golf ball” with the concept of “product”. As another example, the term “Amazon.com” is associated with the concept of “store”. These associations are formed by scanning websites, to obtain conceptual relationships between words, categories, and their contextual relationship within sentences.

The conceptual knowledge database unit 250 also contains knowledge of semantic relations 256 between words, or clusters of words, that bear concepts. For example, “programming in Java” has the semantic relation: “action-means”.

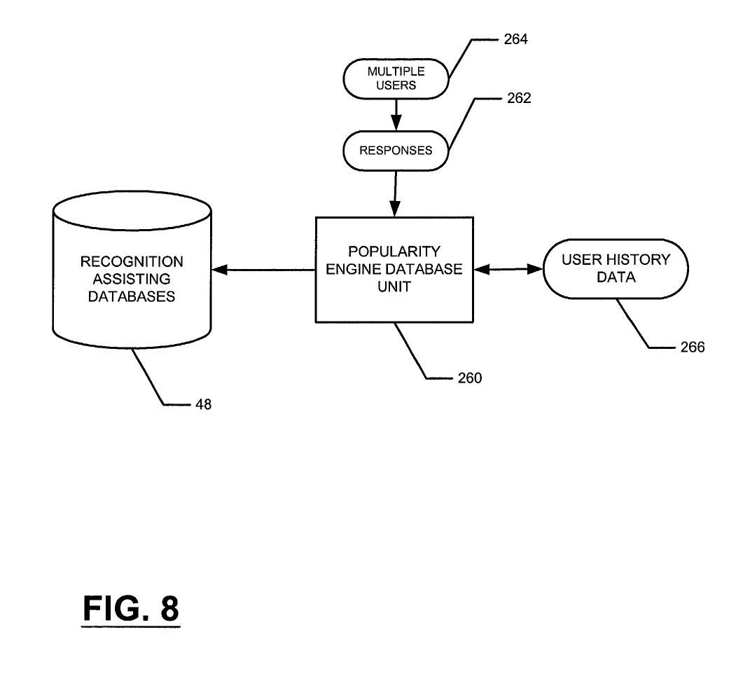

FIG. 8 depicts the popularity engine database unit 260 that forms one of the recognition assisting databases 48. The popularity engine database unit 260 contains data compiled from multiple users' histories that has been calculated for the prediction of likely user requests. The histories are compiled from the previous responses 262 of the multiple users 264. The response history compilation 266 of the popularity engine database unit 260 increases the accuracy of word recognition. Users belong to various user groups, distinguished on the basis of past behavior, and can be predicted to produce utterances containing keywords from language models relevant to, for example, shopping or weather related services.

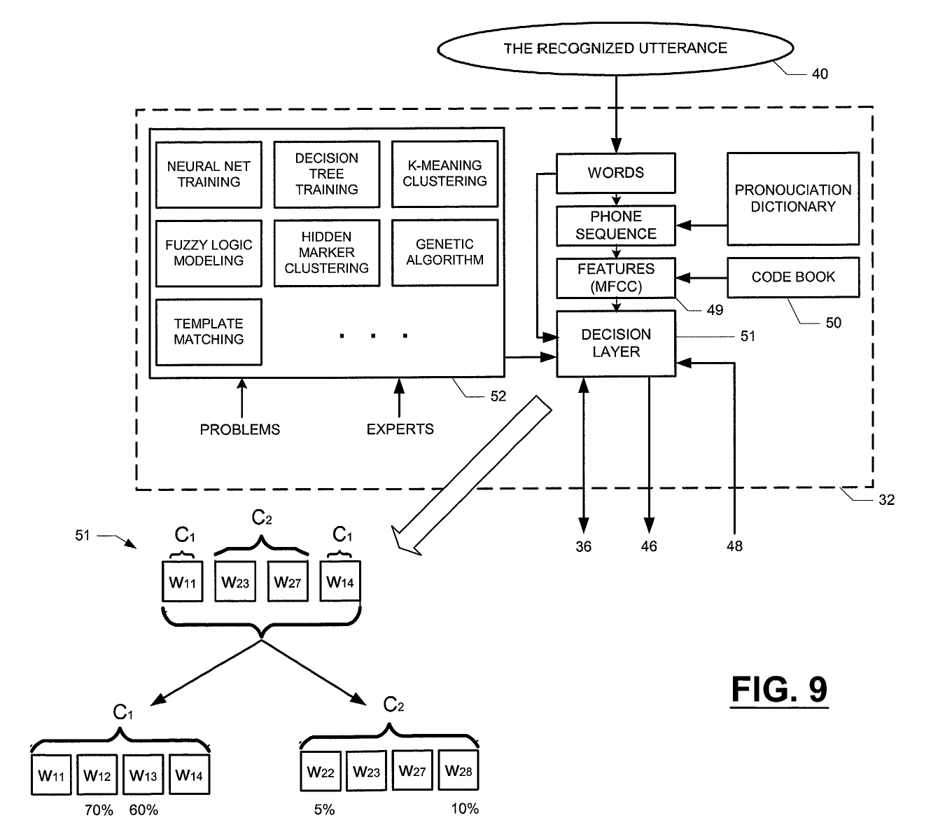

FIG. 9 depicts an embodiment of the present invention for selecting language models. This embodiment utilizes a combination of statistical modeling and conceptual pattern matching with both semantic and phonetic information. The multi-scan control unit 32 receives an initially recognized utterance 40 from the user as a word sequence. The output is first normalized to a standard format. Next semantic and phonetic features are extracted from the normalized word sequence. Then the acoustic features of the input utterance, in the form of Mel-Frequency Cepstral Coefficients (mfcc) 49, of each frame of the input utterance is mapped against the code book models 50 of each of the phonetic segment of the recognized words to calculate their confidence levels. The semantic feature of the recognized words is represented as attribute-and-value matrices. These include semantic category, syntactic category, application-relevancy, topic-indicator, etc. This representation is then fed into a multi-layer perceptron-based neural network decision layer 51, which has been trained by the learning module 52 to map feature structures to sub-language models 36. A sub-language model reflects certain user interests. It could mean a switching from a portal top level node to a specific application; it could also mean a switching from an application top-level node to a special topic or user interest area in that application. The joint use of semantic information and phonetic information has the effect of mutual-supplementation between the words. For example, if two words W1 and W2 are recognized, 51, W1 being correct and W2 being wrong, when matching a conceptual pattern of a correct sub-model (i.e., the first category “C1” sub-model), W1 will have a high semantic score and at the same time W2 will have a high phonetic score as its phonetic and the acoustic feature will match up a word which is mis-recognized. On the other hand, when matching a conceptual pattern from a wrong sub-model (i.e., C2), the semantic score of W1 as well as its phonetic score will all be low, as there is unlikely a word in the wrong pattern having similar pronunciation to it. To further illustrate this point, imagine the user says “I want a Lexmark printer” and the recognizer gives “I want a Lexus printer”. Now imagine two contending sub-models are tried. The C1 sub-model contains words like “I want a Lexmark printer” the second one (C2 sub-model) contains words like “I want a Lexus car”. The C1 sub-model has a significantly higher chance of being selected if both semantic and phonetic information are jointly used. The joint information of semantic and phonetic features is also used to partition large word sets within a conceptual sub-model into further phonetic sub-models.

The preferred embodiment described within this document with reference to the drawing figure(s) is presented only to demonstrate an example of the invention. Additional and/or alternative embodiments of the invention will be apparent to one of ordinary skill in the art upon reading the aforementioned disclosure.

It is claimed:

1. A computer-implemented method for speech recognition of a user speech input, comprising the steps of:
receiving the user speech input that contains utterances from a user;
recognizing by a first language model at least a portion of the utterances from the user speech input, said first language model having utterance terms that form a general category;
selecting a second language model based upon the identified utterances from use of the first language model, said second language model containing utterance terms that are a subset category of the general category of utterance terms in the first language model; and
recognizing with the selected second language model utterances from the user speech input.

2. The method of claim 1 wherein a hierarchy of language models that progresses from general terms to specific terms is used to recognize the utterances from the user speech input.

3. The method of claim 2 further comprising the steps of:
selecting the first language model from the hierarchy of language models to recognize context of the user speech input;
selecting based upon the recognized context of the user speech input the second language model from the hierarchy of language models;
using the selected second language model to recognize specific terms within the user speech input;
using the recognized specific terms to select a third language model from the hierarchy of language models; and
using the selected second language model to recognize terms within the user speech input.

4. The method of claim 3 wherein the language models regard domains, wherein hierarchy of language models is organized based upon the domain to which a language model is directed.

5. The method of claim 4 wherein the language models are hidden Markov language recognition models.

6. The method of claim 3 further comprising the step of:
providing the recognized utterances of the user input speech to an electronic commerce transaction computer server in order to process request of the user input speech.

7. The method of claim 2 further comprising the step of:
using models within the hierarchy of language models for recognizing idioms in the user input speech.

8. The method of claim 1 wherein a web summary knowledge database stores associations between first terms and second terms, wherein the associations indicate that when a first term is used its associated second term has a likelihood to be present, wherein Internet web pages are processed in order to determine the associations between the first and second terms, said method further comprising the step of:
using the stored associations to recognize the utterances within the user input speech.

9. The method of claim 1 wherein a phonetic knowledge unit stores the degree of pronunciation similarity between a first and second term, wherein the phonetic knowledge unit is used to select terms of similar pronunciation for storage in the second language model.

10. The method of claim 1 wherein a conceptual knowledge database unit stores word concept structure and relations, said method further comprising the step of:
using the stored word concept structure and relations to recognize the utterances within the user input speech.

11. The method of claim 1 wherein the recognized utterances are used within a telephony system.
